(19) United States
(12) Patent Application Publication
(10) Pub. No.: US 2023/0409053 A1
(43) Pub. Date: Dec. 21, 2023

(54) FLIGHT COMMAND GENERATION DEVICE AND COMPUTER-READABLE STORAGE MEDIUM

(71) Applicant: FANUC CORPORATION, Yamanashi (JP)

(72) Inventor: Takashi MIYOSHI, Yamanashi (JP)

(21) Appl. No.: 18/252,367

(22) PCT Filed: Nov. 16, 2021
(86) PCT No.: PCT/JP2021/042132

§ 371 Date: May 10, 2023

(30) Foreign Application Priority Data
Nov. 20, 2020 (JP) 2020-193372

(51) Int. Cl. G05D 1/10; G08B 5/36

(52) U.S. Cl. CPC G05D 1/101; G08B 5/36

(57) ABSTRACT

A storage unit configured to store identification information assigned to each of a plurality of industrial machines in association with information indicating a flight position of an unmanned aircraft, an acquisition unit configured to acquire the identification information from at least one industrial machine from among the plurality of industrial machines, and a flight command generation unit configured to generate a flight command for flying the unmanned aircraft at the flight position stored in association with the identification information acquired by the acquisition unit are provided.

### TECHNICAL FIELD

The present invention relates to a flight command generation device and a computer-readable storage medium.

### BACKGROUND ART

Conventionally, a notification device such as PATLITE (registered trademark) attached to an industrial machine has been used to report an operating state of the industrial machine (Patent Document 1). The operating state is, for example, a state in which an alarm is generated in the industrial machine.

### CITATION LIST

### Patent Document

Patent Document 1: JP 2017-80842 A

### SUMMARY OF THE INVENTION

### Problem to be Solved by the Invention

However, when a large number of industrial machines are disposed in a factory, even if operating states are reported using notification devices attached to the industrial machines, an operator may not be able to visually recognize a notification device because it is hidden behind other industrial machines. For this reason, there is concern that the operating states of the industrial machines cannot be reported to the operator.

An object of the present invention is to provide a flight command generation device and a computer-readable storage medium capable of reliably notify an operator of an operating state of an industrial machine.

### Means for Solving Problem

A flight command generation device includes a storage unit configured to associate and store identification information assigned to each of a plurality of industrial machines and information indicating a flight position of an unmanned aircraft, an acquisition unit configured to acquire the identification information from at least one industrial machine from among the plurality of industrial machines, and a flight command generation unit configured to generate a flight command for flying the unmanned aircraft at the flight position stored in association with the identification information acquired by the acquisition unit.

A computer-readable storage medium stores an instruction for causing a computer to execute associating and storing identification information assigned to each of a plurality of industrial machines and information indicating a flight position of an unmanned aircraft, acquiring the identification information from at least one industrial machine from among the plurality of industrial machines, and generating a flight command for flying the unmanned aircraft at the flight position stored in association with the acquired identification information.

### Effect of the Invention

According to the present invention, it is possible to reliably notify an operator of an operating state of an industrial machine.

### BRIEF DESCRIPTION OF DRAWINGS

FIG. 1 is a diagram for describing an example of an entire flight command generation system;

FIG. 2 is a diagram illustrating an example of a hardware configuration of a flight command generation device;

FIG. 3 is a diagram illustrating an example of a hardware configuration of an unmanned aircraft;

FIG. 4 is a diagram illustrating an example of a hardware configuration of an industrial machine;

FIG. 5 is a diagram for describing an example of functions of the flight command generation device;

FIG. 6 is a diagram for describing an example of information stored in a storage unit;

FIG. 7 is a diagram illustrating an example of functions of the unmanned aircraft;

FIG. 8 is a diagram illustrating an example of functions of a numerical controller; and

FIG. 9 is a flowchart illustrating an example of processing executed in the flight command generation device.

### MODE(S) FOR CARRYING OUT THE INVENTION

An embodiment of the invention will be described below with reference to the drawings. Note that not all combinations of features described in the following embodiment are necessarily required to solve the problem. Further, more detailed description than necessary may be omitted. In addition, the following description of the embodiment and drawings are provided for those skilled in the art to fully understand the invention, and are not intended to limit the scope of the claims.

First, an entire flight command generation system including a flight command generation device will be described.

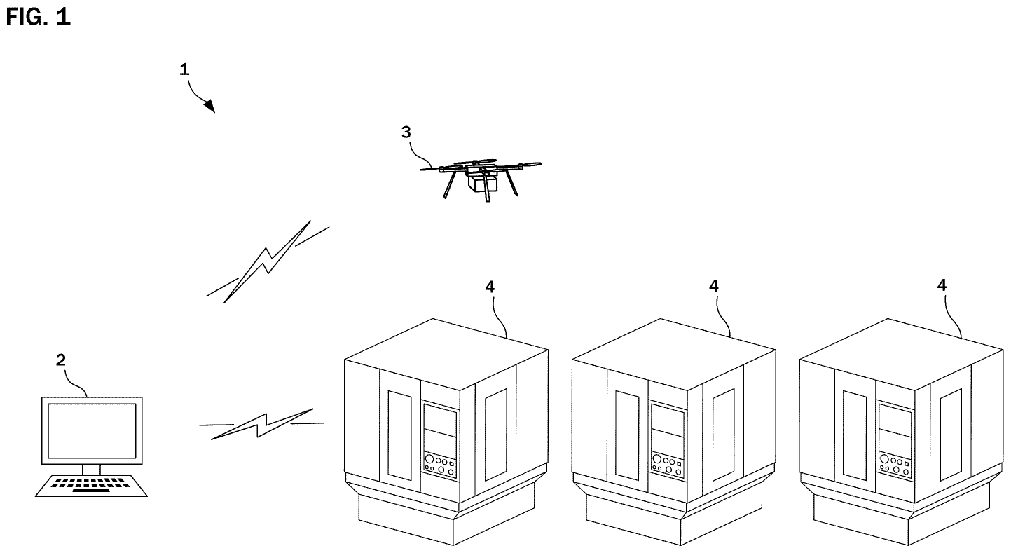

FIG. 1 is a diagram for describing an example of the entire flight command generation system.

The flight command generation system 1 includes a flight command generation device 2, an unmanned aircraft 3, and a plurality of industrial machines 4.

The flight command generation device 2 outputs a flight command to the unmanned aircraft 3 to cause the unmanned air craft 3 to notify an operating state of an industrial machine 4. The flight command generation device 2 is implemented in, for example, a PC (Personal Computer) or a server. The flight command generation device 2 is installed, for example, in a factory or in a building different from the factory.

The unmanned aircraft 3 is a multicopter-type small unmanned aircraft. The unmanned aircraft 3 is referred to as a drone. The unmanned aircraft 3 flies toward a flight position corresponding to each of the plurality of industrial machines 4 according to a flight command generated by the flight command generation device 2, and reports the operating state of the industrial machine 4 at this flight position. The unmanned aircraft 3 flies around in the factory until receiving a flight command. In addition, the unmanned aircraft 3 may charge a battery at a predetermined base until receiving a flight command.

The industrial machine 4 is a device installed in a factory to perform various operations. The industrial machine 4 is, for example, a machine tool or an industrial robot. In addition, the industrial machine 4 includes a numerical controller. The numerical controller is a controller that controls the entire industrial machine 4.

Next, a description will be given of a hardware configuration of each device included in the flight command generation system 1.

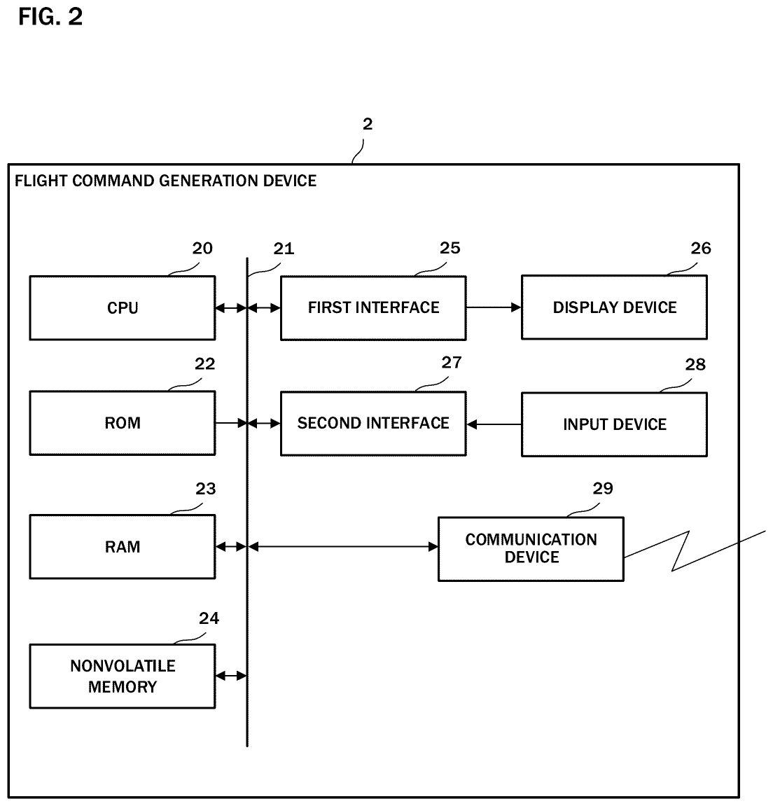

FIG. 2 is a diagram illustrating an example of a hardware configuration of the flight command generation device 2. The flight command generation device 2 includes a CPU (Central Processing Unit) 20, a bus 21, a ROM (Read Only Memory) 22, a RAM (Random Access Memory) 23, and a nonvolatile memory 24.

The CPU 20 is a processor that controls the entire flight command generation device 2 according to a system program. The CPU 20 reads a system program, etc. stored in the ROM 22 via the bus 21.

The bus 21 is a communication path that connects respective pieces of hardware in the flight command generation device 2 to each other. The respective pieces of hardware in the flight command generation device 2 exchange data via the bus 21.

The ROM 22 is a storage device that stores a system program, etc. for controlling the entire flight command generation device 2.

The RAM 23 is a storage device that temporarily stores various data. The RAM 23 functions as a work area for processing various data by the CPU 20.

The nonvolatile memory 24 is a storage device that retains data even in a state where the flight command generation device 2 is powered off and power is not supplied to the flight command generation device 2. For example, the nonvolatile memory 24 includes an SSD (Solid State Drive).

The flight command generation device 2 further includes a first interface 25, a display device 26, a second interface 27, an input device 28, and a communication device 29.

The first interface 25 connects the bus 21 and the display device 26 to each other. For example, the first interface 25 transmits various data processed by the CPU 20 to the display device 26.

The display device 26 receives various data via the first interface 25 and displays various data. The display device 26 is a display such as an LCD (Liquid Crystal Display).

The second interface 27 connects the bus 21 and the input device 28 to each other. For example, the second interface 27 transmits data input from the input device 28 to the CPU 20 via the bus 21.

The input device 28 is a device for inputting various data. For example, the input device 28 receives input of data, and transmits the input data to the nonvolatile memory 24 via the second interface 27. For example, the input device 28 is a keyboard and a pointing device. Note that, for example, the input device 28 and the display device 26 may be configured as one device such as a touch panel.

The communication device 29 is a device that performs wireless communication with the unmanned aircraft 3. For example, the communication device 29 performs communication using a wireless LAN or Bluetooth.

In addition, the communication device 29 is a device that communicates with the industrial machine 4 by wire or wirelessly. When the communication device 29 communicates with the industrial machine 4, communication is performed using, for example, an Internet line.

Next, a hardware configuration of the unmanned aircraft 3 will be described.

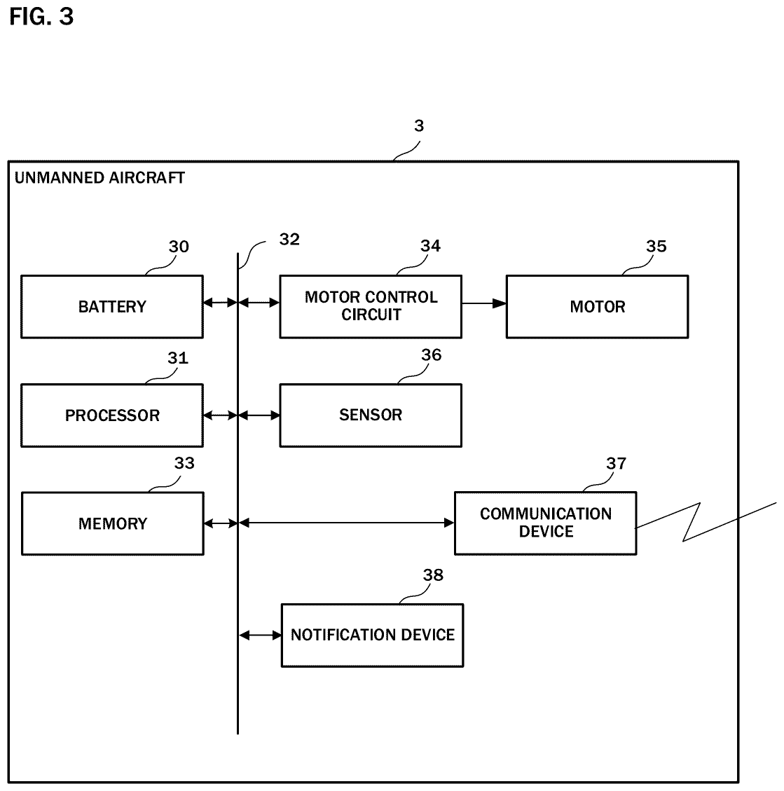

FIG. 3 is a diagram illustrating an example of the hardware configuration of the unmanned aircraft 3. The unmanned aircraft 3 includes a battery 30, a processor 31, a bus 32, a memory 33, a motor control circuit 34, a motor 35, a sensor 36, a communication device 37, and a notification device 38.

The battery 30 supplies power to each part of the unmanned aircraft 3. For example, the battery 30 is a lithium-ion battery.

The processor 31 controls the entire unmanned aircraft 3 according to a control program. For example, the processor 31 functions as a flight controller. For example, the processor 31 is a CPU.

The bus 32 is a communication path that connects respective pieces of hardware in the unmanned aircraft 3 to each other. The respective pieces of hardware in the unmanned aircraft 3 exchange data via the bus 32.

The memory 33 is a storage device that stores various programs, data, etc. The memory 33 stores, for example, a control program for controlling the entire unmanned aircraft 3. The memory 33 is, for example, a ROM, a RAM, and an SSD.

The motor control circuit 34 is a circuit for controlling the motor 35. The motor control circuit 34 drives and controls the motor 35 by receiving a control command from the processor 31.

The motor 35 is controlled by the motor control circuit 34. The motor 35 rotates a propeller fixed to a rotating shaft. Note that even though FIG. 3 illustrates one motor 35, for example, the unmanned aircraft 3 includes four motors 35, and the motor control circuit 34 controls rotation of each of the motors 35 to fly the unmanned aircraft 3.

For example, the sensor 36 is a ranging sensor. For example, the sensor 36 measures a distance to a mark attached to a predetermined location on the industrial machine 4. For example, the ranging sensor is a ranging sensor using infrared rays, radio waves, or ultrasonic waves. For example, the sensor 36 may include an electronic compass. The electronic compass detects magnetism of the earth to acquire a direction in which the unmanned aircraft 3 is directed. In addition, the sensor 36 may include an acceleration sensor, an angular velocity sensor, etc.

The communication device 37 communicates with the flight command generation device 2 by wireless communication. As described above, for example, the communication device 37 performs communication using a wireless LAN or Bluetooth.

The notification device 38 is a device that reports the operating state of the industrial machine 4. The notification device reports the operating state of the industrial machine 4 by, for example, lighting modes such as a color of a lamp, lighting of the lamp, or blinking of the lamp. The notification device 38 may have, for example, a device that reports the operating state of the industrial machine 4 by sound. That is, the notification device 38 may have a speaker. In addition, the notification device 38 may have a display device. In this case, the notification device 38 can display information indicating the operating state of the industrial machine 4 on the display device.

Next, a hardware configuration of the industrial machine 4 will be described.

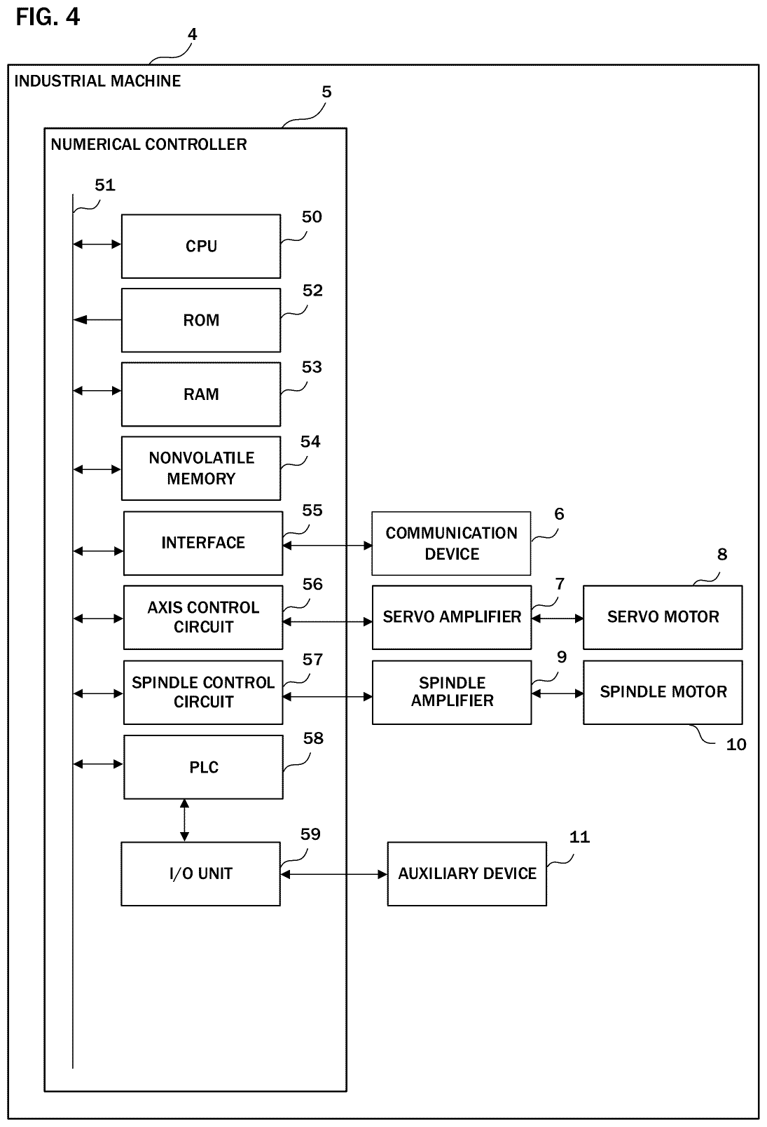

FIG. 4 is a diagram illustrating an example of the hardware configuration of the industrial machine 4. The industrial machine 4 includes a numerical controller 5, a communication device 6, a servo amplifier 7, a servo motor 8, a spindle amplifier 9, a spindle motor 10, and an auxiliary device 11.

The numerical controller 5 is a device that controls the entire industrial machine 4. The numerical controller 5 includes a CPU 50, a bus 51, a ROM 52, a RAM 53, and a nonvolatile memory 54.

The CPU 50 is a processor that controls the entire numerical controller 5 according to a system program. The CPU 50 reads a system program, etc. stored in the ROM 52 via the bus 51. In addition, the CPU 50 controls the servo motor 8 and the spindle motor 10 according to a machining program to machine the workpiece.

The bus 51 is a communication path that connects respective pieces of hardware in the numerical controller 5 to each other. The respective pieces of hardware in the numerical controller 5 exchange data via the bus 51.

The ROM 52 is a storage device that stores a system program, etc. for controlling the entire numerical controller 5.

The RAM 53 is a storage device that temporarily stores various data. The RAM 53 functions as a working area for processing various data by the CPU 50.

The nonvolatile memory 54 is a storage device that retains data even in a state where the industrial machine 4 is powered off and power is not supplied to the numerical controller 5. For example, the nonvolatile memory 54 includes an SSD.

The numerical controller 5 further includes an interface 55, an axis control circuit 56, a spindle control circuit 57, a PLC (Programmable Logic Controller) 58, and an I/O unit 59.

The interface 55 is a communication path that connects the bus 51 and the communication device 6 to each other. For example, the interface 55 transmits various data received by the communication device 6 to the CPU 50.

The communication device 6 communicates with the flight command generation device 2. As described above, the communication device 6 performs communication using, for example, an Internet line.

The axis control circuit 56 is a circuit that controls the servo motor 8. The axis control circuit 56 receives a control command from the CPU 50 and outputs a command for driving the servo motor 8 to the servo amplifier 7. For example, the axis control circuit 56 transmits a torque command for controlling torque of the servo motor 8 to the servo amplifier 7.

The servo amplifier 7 receives a command from the axis control circuit 56 and supplies power to the servo motor 8.

The servo motor 8 is driven by receiving power supply from the servo amplifier 7. When the industrial machine 4 is a machine tool, for example, the servo motor 8 is coupled to a ball screw that drives a tool post, a spindle head, and a table. When the servo motor 8 is driven, structures of the machine tool such as the tool post, the spindle head, and the table are moved in, for example, the X-axis direction, the Y-axis direction, or the Z-axis direction.

The spindle control circuit 57 is a circuit for controlling the spindle motor 10. The spindle control circuit 57 receives a control command from the CPU 50 and outputs a command for driving the spindle motor 10 to the spindle amplifier 9. For example, the spindle control circuit 57 transmits a torque command for controlling torque of the spindle motor 10 to the spindle amplifier 9.

The spindle amplifier 9 receives a command from the spindle control circuit 57 and supplies power to the spindle motor 10.

The spindle motor 10 is driven by receiving power supply from the spindle amplifier 9. The spindle motor 10 is coupled to a spindle and rotates the spindle.

The PLC 58 is a device that executes a ladder program to control the auxiliary device 11. The PLC 58 controls the auxiliary device 11 via the I/O unit 59.

The I/O unit 59 is an interface that connects the PLC 58 and the auxiliary device 11 to each other. The I/O unit 59 transmits a command received from the PLC 58 to the auxiliary device 11.

The auxiliary device 11 is installed in the industrial machine 4 and performs an auxiliary operation when the industrial machine 4 machines a workpiece. The auxiliary device 11 may be a device installed around the industrial machine 4. The auxiliary device 11 is, for example, a tool changer, a cutting fluid injection device, or an open/close door driving device.

Next, a function of each unit of the flight command generation device 2 will be described.

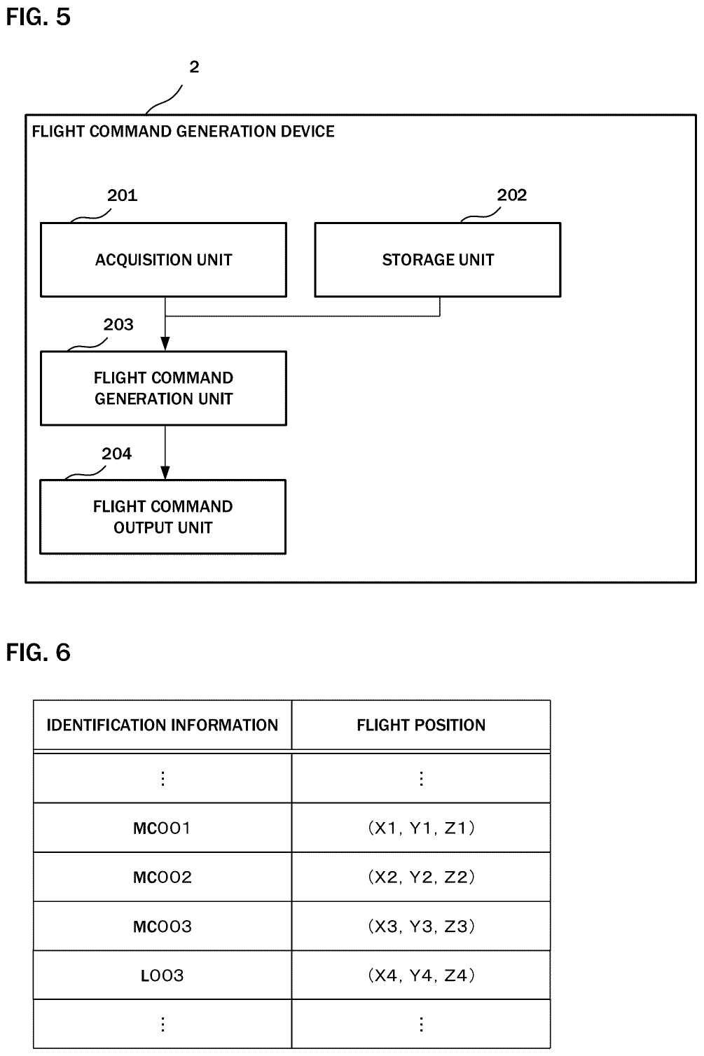

FIG. 5 is a block diagram illustrating an example of the function of each unit of the flight command generation device 2. The flight command generation device 2 includes an acquisition unit 201, a storage unit 202, a flight command generation unit 203, and a flight command output unit 204.

For example, the acquisition unit 201, the flight command generation unit 203, and the flight command output unit 204 are realized by the CPU 20 performing arithmetic processing using a system program stored in the ROM 22 and various data. In addition, for example, the storage unit 202 is realized by data input from an input device 28, etc. or a calculation result of arithmetic processing by the CPU being stored in the RAM 23 or the nonvolatile memory 24.

The acquisition unit 201 acquires, from at least one industrial machine 4 among the plurality of industrial machines 4 disposed in the factory, identification information of the industrial machine 4. For example, the acquisition unit 201 acquires the identification information from the numerical controller 5 using the communication device 29.

The identification information is unique information assigned to each of the plurality of industrial machines 4 disposed in the factory. The identification information is, for example, information of a combination of an alphabet indicating a type of machine and a numerical value of several digits.

The acquisition unit 201 further acquires operation information indicating the operating state of the industrial machine 4 from the at least one industrial machine 4.

The operating state is, for example, a state in which the industrial machine is normally operating, or a state in which an alarm is generated in the industrial machine 4. In other words, the operation information indicating the operating state includes information indicating a state in which the industrial machine 4 is normally operating or information indicating that an alarm is generated. In addition, the operation information may include information indicating a type of alarm generated in the industrial machine 4.

The alarm is, for example, an alarm indicating that a tool used in the industrial machine 4 has reached an end of a tool lifespan. In addition, the alarm is, for example, an alarm indicating that a servo motor or a spindle motor is overloaded. In addition, the alarm is, for example, an alarm indicating that a temperature of a cutting fluid exceeds a predetermined threshold value.

The storage unit 202 associates and stores identification information assigned to each of the plurality of industrial machines 4 and information indicating a flight position of the unmanned aircraft 3.

FIG. 6 is a diagram for describing an example of information stored in the storage unit 202. The storage unit 202 stores identification information of the industrial machines 4 disposed in the factory in association with coordinate values indicating the flight position of the unmanned aircraft 3. The coordinate values indicating the flight position are, for example, coordinate values in a three-dimensional orthogonal coordinate system in which a predetermined position in the factory is set as the origin. The coordinate values indicating the flight position are a position corresponding to a location where the industrial machine 4 is disposed. The position corresponding to the location where the industrial machine 4 is disposed is, for example, a position directly above the numerical controller 5 of the industrial machine 4 corresponding to the identification information and having a height of 5 [m].

Here, description returns to FIG. 5.

The flight command generation unit 203 generates a flight command for flying the unmanned aircraft 3 at the flight position stored in association with the identification information acquired by the acquisition unit 201. The flight command generation unit 203 refers to the information stored in the storage unit 202, and specifies a flight position stored in association with the identification information of the industrial machine 4.

The flight command generated by the flight command generation unit 203 includes a command for causing a notification unit included in the unmanned aircraft 3 to report the operating state of the industrial machine 4. For example, when the operation information acquired by the acquisition unit 201 includes information indicating generation of an alarm, the flight command includes a command for causing the notification unit of the unmanned aircraft 3 to report generation of the alarm. For example, the command for reporting generation of the alarm is a command for causing the notification unit of the unmanned aircraft 3 to light a red lamp.

Further, when the operation information acquired by the acquisition unit 201 includes information indicating the type of alarm, the flight command includes a command for causing the notification unit of the unmanned aircraft 3 to report the type of alarm. For example, when the operation information includes information indicating generation of an alarm related to a tool lifespan, the flight command includes a command for reporting generation of the alarm related to the tool lifespan. The command for reporting generation of the alarm related to the tool lifespan is, for example, a command for causing the notification unit of the unmanned aircraft 3 to light a yellow lamp.

The command for reporting the operating state of the industrial machine may include a command for flying the unmanned aircraft 3 in a flight mode for reporting the operating state of the industrial machine 4. The command for reporting the operating state of the industrial machine 4 is, for example, a command for causing the unmanned aircraft 3 to hover at the flight position stored in the storage unit 202. Further, the command for reporting the operating state of the industrial machine 4 may include, for example, a command for flying the unmanned aircraft 3 in a flight mode for repeating movement in a vertical direction or a horizontal direction around the flight position stored in the storage unit 202. Alternatively, the command for reporting the operating state of the industrial machine 4 may include a command for flying the unmanned aircraft 3 in a flight mode for rotating about or circling around a vertical axis passing through the flight position stored in the storage unit 202.

The flight command output unit 204 outputs a flight command generated by the flight command generation unit 203. The flight command output unit 204 transmits the flight command to the unmanned aircraft 3 using the communication device 29. In other words, the flight command generation device 2 indirectly controls flight of the unmanned aircraft 3.

Next, a function of each unit of the unmanned aircraft 3 will be described.

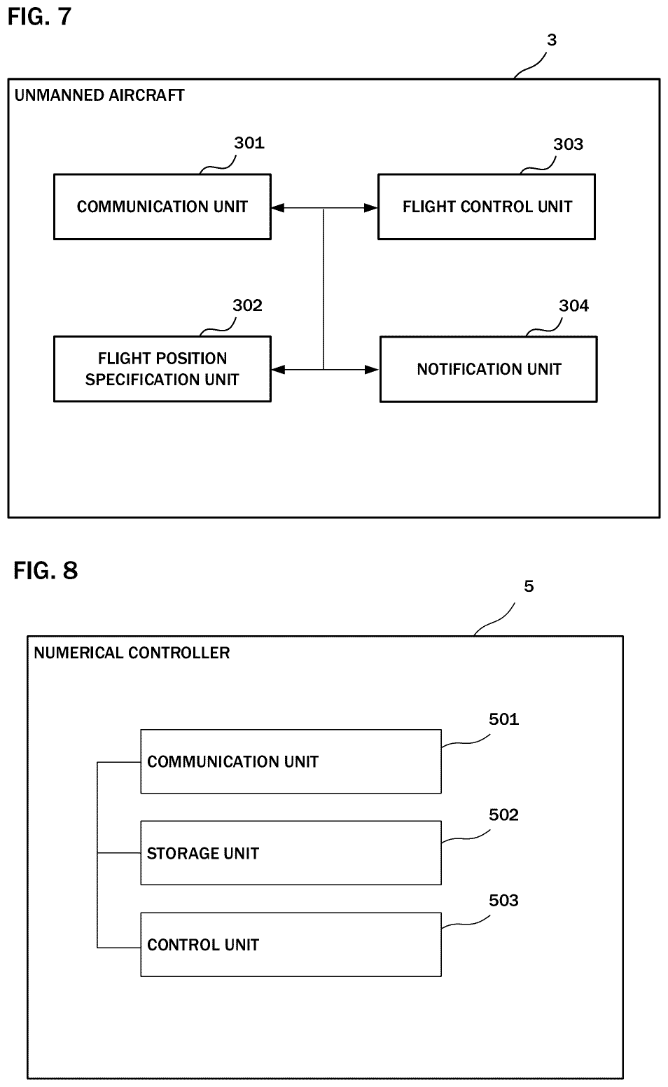

FIG. 7 is a block diagram illustrating an example of the function of each unit of the unmanned aircraft 3. The unmanned aircraft 3 includes a communication unit 301, a flight position specification unit 302, a flight control unit 303, and a notification unit 304.

The communication unit 301 communicates with the flight command generation device 2. For example, the communication unit 301 receives a flight command from the flight command generation device 2.

The flight position specification unit 302 specifies a flight position of the unmanned aircraft 3. For example, the flight position specification unit 302 specifies a flight position and orientation of the unmanned aircraft 3 by detecting a mark attached to the inside of the factory and the industrial machine 4 using the sensor 36. In addition, when the unmanned aircraft 3 includes a GPS (Global Positioning System) receiver, the flight position specification unit 302 may specify the flight position of the unmanned aircraft 3 using a GPS. Alternatively, the unmanned aircraft 3 may be detected by a sensor installed in the factory or on the industrial machine 4, and the flight position specification unit 302 may calculate a position and orientation of the unmanned aircraft 3 based on detection information received from the sensor. Alternatively, the position of the unmanned aircraft 3 may be specified by combining these methods.

The flight control unit 303 executes flight control of the unmanned aircraft 3 based on the flight command acquired by the communication unit 301 and the position information of the unmanned aircraft 3 specified by the flight position specification unit 302. The flight control unit 303 executes flight control by controlling a rotation speed of each motor 35. The flight control unit 303 causes the unmanned aircraft 3 to fly in a flight position indicated by the flight command. In addition, the flight control unit 303 performs feedback control using information indicating the flight position of the unmanned aircraft 3 specified by the flight position specification unit 302.

For example, when a flight position (Xl, Y1, Z1) is designated in the flight command, the flight control unit 303 causes the unmanned aircraft 3 to fly to the flight position (Xl, Y1, Z1) and hover. Further, when the flight command includes a command for flying the unmanned aircraft 3 in a predetermined flight mode, the flight control unit 303 flies the unmanned aircraft 3 in the predetermined flight mode. As described above, the predetermined flight mode is such as a flight mode in which the unmanned aircraft 3 repeatedly moves in the vertical direction or the horizontal direction.

The notification unit 304 reports the operating state of the industrial machine 4. When the flight command includes a command for reporting generation of an alarm, the notification unit 304 reports generation of the alarm in the industrial machine 4. For example, the notification unit 304 reports generation of the alarm in the industrial machine 4 by lighting a red lamp.

In addition, when information indicating a type of alarm is included in the flight command, the notification unit 304 reports the type of alarm generated in the industrial machine 4. For example, when the flight command includes information indicating that the tool has reached the end of the tool lifespan, the notification unit 304 lights a yellow lamp to report the type of alarm generated in the industrial machine 4.

In addition, for example, the notification unit 304 may report that the alarm is generated in the industrial machine 4 or the type of alarm by sound. For example, the notification unit 304 can report the alarm using different sound for each type of alarm.

Next, a function of each unit of the numerical controller 5 included in the industrial machine 4 will be described.

FIG. 8 is a block diagram illustrating an example of the function of each unit of the numerical controller 5.

The numerical controller 5 includes a communication unit 501, a storage unit 502, and a control unit 503.

The communication unit 501 communicates with the flight command generation device 2. For example, the communication unit 501 transmits operation information indicating the operating state of the industrial machine 4 to the flight command generation device 2.

For example, the storage unit 502 stores a system program for controlling the entire numerical controller 5, a machining program, and information related to tool offset.

The control unit 503 controls the entire industrial machine 4. For example, the control unit 503 executes machining of the workpiece according to a machining program.

Next, a description will be given of a flow of processing executed in the flight command generation device 2.

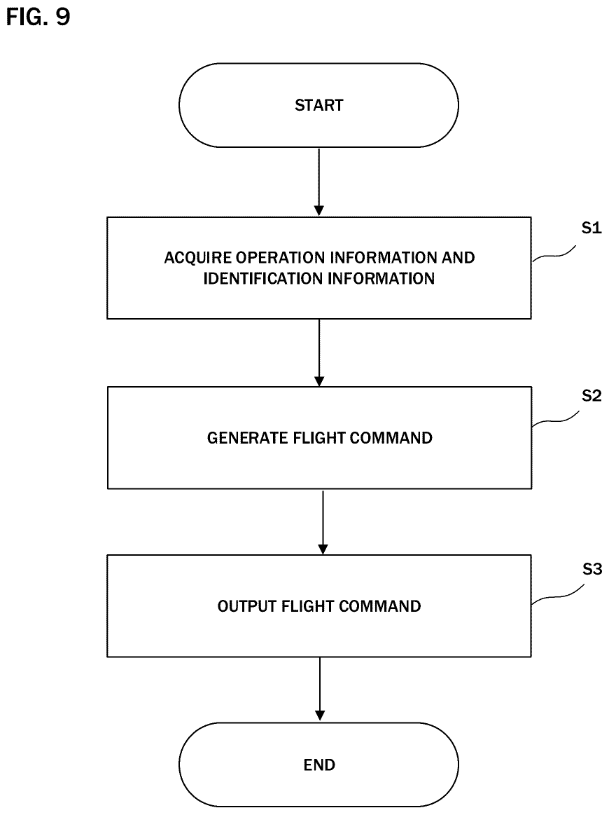

FIG. 9 is a flowchart illustrating an example of processing executed in the flight command generation device 2.

First, the acquisition unit 201 acquires identification information from the numerical controller 5 (step S1). At this time, the acquisition unit 201 may acquire operation information indicating the operating state of the industrial machine 4.

Next, the flight command generation unit 203 generates a flight command for flying the unmanned aircraft 3 at the flight position stored in association with the identification information (step S2).

Next, the flight command output unit 204 outputs a flight command to the unmanned aircraft 3 (step S3), and the process ends.

By executing such processing in the flight command generation device 2, it is possible to cause the unmanned aircraft 3 to report the operating state of the industrial machine 4.

As described above, the storage unit 202 that stores identification information assigned to each of the plurality of industrial machines 4 in association with information indicating a flight position of the unmanned aircraft 3, the acquisition unit 201 that acquires identification information from at least one industrial machine 4 from among the plurality of industrial machines, and the flight command generation unit 203 that generates a flight command for flying the unmanned aircraft 3 at the flight position stored in association with the identification information acquired by the acquisition unit 201 are provided. For this reason, the unmanned aircraft 3 can be flown at a flight position corresponding to the industrial machine 4. In this way, the operating state of the industrial machine can be reliably reported to the operator.

The acquisition unit 201 acquires operation information indicating the operating state of the at least one industrial machine 4 from the at least one industrial machine 4. Further, the flight command generated by the flight command generation unit 203 includes a command for causing the notification unit 304 provided in the unmanned aircraft 3 to report the operating state. Further, the flight command generated by the flight command generation unit 203 includes a command for causing the unmanned aircraft 3 to fly in a flight mode for reporting the operating state. Therefore, the flight command generation device 2 can reliably notify the operator of the operating state of the industrial machine 4 by using the unmanned aircraft 3.

Further, the flight mode of the unmanned aircraft 3 includes a flight mode in which the unmanned aircraft 3 repeatedly moves in the vertical direction, a flight mode in which the unmanned aircraft 3 repeatedly moves in the horizontal direction, or a flight mode in which the unmanned aircraft 3 circles around the vertical axis. For this reason, by allowing the operator to confirm the flight mode of the unmanned aircraft 3, the operating state of the industrial machine 4 can be reliably reported to the operator.

Note that, even though the flight command generation device 2 is implemented in a PC or a server, in the above-described embodiment, the flight command generation device 2 may be implemented in the numerical controller 5.

### EXPLANATIONS OF LETTERS OR NUMERALS

1 FLIGHT COMMAND GENERATION SYSTEM
2 FLIGHT COMMAND GENERATION DEVICE
20 CPU
21 BUS
22 ROM
23 RAM
24 NONVOLATILE MEMORY
25 FIRST INTERFACE
26 DISPLAY DEVICE
27 SECOND INTERFACE
28 INPUT DEVICE
29 COMMUNICATION DEVICE
201 ACQUISITION UNIT
202 STORAGE UNIT
203 FLIGHT COMMAND GENERATION UNIT
204 FLIGHT COMMAND OUTPUT UNIT
3 UNMANNED AIRCRAFT
30 BATTERY
31 PROCESSOR
32 BUS
33 MEMORY
34 MOTOR CONTROL CIRCUIT
35 MOTOR
36 SENSOR
37 COMMUNICATION DEVICE
38 NOTIFICATION DEVICE
301 COMMUNICATION UNIT
302 FLIGHT POSITION SPECIFICATION UNIT
303 FLIGHT CONTROL UNIT
304 NOTIFICATION UNIT
4 INDUSTRIAL MACHINE
5 NUMERICAL CONTROLLER
50 CPU
51 BUS
52 ROM
53 RAM
54 NONVOLATILE MEMORY
55 INTERFACE
56 AXIS CONTROL CIRCUIT
57 SPINDLE CONTROL CIRCUIT
58 PLC
59 I/O UNIT
501 COMMUNICATION UNIT
502 STORAGE UNIT
503 CONTROL UNIT
6 COMMUNICATION DEVICE
7 SERVO AMPLIFIER
8 SERVO MOTOR
9 SPINDLE AMPLIFIER
10 SPINDLE MOTOR
11 AUXILIARY DEVICE

1. A flight command generation device comprising:
a storage unit configured to store identification information assigned to each of a plurality of industrial machines in association with information indicating a flight position of an unmanned aircraft;
an acquisition unit configured to acquire the identification information from at least one industrial machine from among the plurality of industrial machines; and
a flight command generation unit configured to generate a flight command for flying the unmanned aircraft at the flight position stored in association with the identification information acquired by the acquisition unit.

2. The flight command generation device according to claim 1, wherein the acquisition unit further acquires operation information indicating an operating state of the at least one industrial machine from the at least one industrial machine.

3. The flight command generation device according to claim 2, wherein the flight command includes a command for causing a notification unit provided in the unmanned aircraft to report the operating state.

4. The flight command generation device according to claim 2, wherein the operating state is a state in which an alarm is generated in the industrial machine.

5. The flight command generation device according to claim 2, wherein the flight command includes a command for causing the unmanned aircraft to fly in a flight mode for reporting the operating state.

6. The flight command generation device according to claim 5, wherein the flight mode includes at least one of a flight mode in which the unmanned aircraft repeatedly moves in a vertical direction, a flight mode in which the unmanned aircraft repeatedly moves in a horizontal direction, and a flight mode in which the unmanned aircraft circles around a vertical axis.

7. A storage medium storing an instruction for causing a computer to execute:
storing identification information assigned to each of a plurality of industrial machines in association with information indicating a flight position of an unmanned aircraft;
acquiring the identification information from at least one industrial machine from among the plurality of industrial machines; and
generating a flight command for flying the unmanned aircraft at the flight position stored in association with the acquired identification information.
